(19) United States
(12) Patent Application Publication
(10) Pub. No.: US 2022/0058179 A1
(43) Pub. Date: Feb. 24, 2022

(54) EXECUTING DATABASE TRANSACTIONS

(71) Applicant: International Business Machines Corporation, Armonk, NY (US)

(72) Inventors: Knut Stolze, Hummelshain (DE); Felix Beier, Haigerloch (DE); Luis Eduardo Oliveira Lizardo, Boblingen (DE); Reinhold Geiselhart, Rottenburg-Ergenzingen (DE)

(21) Appl. No.: 17/001,407

(22) Filed: Aug. 24, 2020

(51) Int. Cl. G06F 16/23

(52) U.S. Cl. CPC G06F 16/2379

(57) ABSTRACT

In an approach for executing a set of one or more database transactions in a database system, a processor provides a detection storage configured such that an entry of a database transaction that is stored in the detection storage is automatically deleted in case the database transaction ends, wherein the database transaction comprises a set of operations. For each database transaction of a set of database transactions: a processor adds an entry in the detection storage and a processor executes the database transaction, the execution comprising for at least one operation of the set of operations: executing the at least one operation, determining that the detection storage is empty based on the detection storage not comprising at least the entry of the database transaction, and responsive to determining that the detection storage is empty, determining, by one or more processors, that the database transaction has ended.

### BACKGROUND

The present invention relates to the field of digital computer systems, and more specifically, to an approach for executing a set of one or more database transactions.

One or more Structured Query Language (SQL) statements may be executed in a database transaction. The statement's effect becomes durable when the transaction is committed. If the transaction is rolled back, the actions of all SQL statements within that transaction are rolled back/undone. A database system may have many different error codes indicative of errors occurred during execution of database transactions. For example, those errors may be emitted whenever the execution of a SQL statement has failed, and they may depend on the specific SQL statement and the context in which they are executed. However, error handling may be a challenging task.

### SUMMARY

Various embodiments provide a method, computer system, and computer program product for executing a set of one or more database transactions as described by the subject matter of the independent claims. Advantageous embodiments are described in the dependent claims. Embodiments of the present invention can be freely combined with each other if they are not mutually exclusive.

In one aspect, the invention relates to a computer implemented method for executing a set of one or more database transactions in a database system. The method comprises providing a detection storage configured such that an entry of a database transaction that is stored in the detection storage is automatically deleted in case the database transaction ends, wherein the database transaction comprises a set of operations. The method comprises, for each database transaction of a set of database transactions: adding an entry in the detection storage; and executing the database transaction, the execution comprising, for each operation of the set of operations: executing the at least one operation; determining that the detection storage is empty based on the detection storage not comprising at least the entry of the database transaction; and responsive to determining that the detection storage is empty, determining that the database transaction has ended.

In another aspect, the invention relates to a computer program product comprising a computer-readable storage medium having computer-readable program code embodied therewith, the computer-readable program code configured to implement all of steps of the method according to preceding embodiments.

In another aspect, the invention relates to a computer system for executing a set of one or more database transactions, the database transaction comprising a set of operations. The computer system is configured for: providing a detection storage configured such that an entry of a database transaction that is stored in the detection storage is automatically deleted in case the database transaction ends; and for each database transaction of a set of database transactions: adding an entry in the detection storage; and executing the database transaction, the execution comprising, for each operation of the set of operations: executing the at least one operation; determining that the detection storage is empty based on the detection storage not comprising at least the entry of the database transaction; and responsive to determining that the detection storage is empty, determining that the database transaction has ended.

A database transaction may be a set of operations that perform a task together. A database transaction may be a unit of work performed against a database and treated in a coherent and reliable way independent of other transactions. The database transaction may be an atomic transaction, wherein the set of operations is an indivisible and irreducible series of database operations such that either all occur, or nothing may occur. A database transaction may generally represent any change in a database. The database transaction may, for example, perform a task such as: entering an account debit or credit, or requesting an inventory list.

For example, a database transaction may be issued to a database system in a language like SQL wrapped in a transaction, using a pattern similar to the following: s1) Begin the transaction, s2) Execute a set of data manipulations and/or queries, s3) If no errors occur then commit the transaction and end it and s4) If errors occur then roll back the transaction and end it. A transaction commit operation may apply all data manipulations within the scope of the transaction and persists the results to the database. A database transaction may thus successfully end or unsuccessfully end. If the transaction is committed, then the transaction ended successfully (e.g. s3). If the transaction is rolled back, then the transaction ended unsuccessfully (e.g. s4).

However, the detection of the end of a database transaction may be a challenging task. The present subject matter may enable an efficient detection of the end of the transactions because the present subject matter uses a simplified implementation that may rely on existing resources of the database system.

Detecting the successful end of a database transaction may be advantageous because it may be performed quickly and thus may enable an optimal online system. For example, one of the main characteristics of a transaction system is that the interactions between a user and the system may need to be very short. The present subject matter may enable the user to perform a complete business transaction through short interactions, with immediate response time required for each interaction.

Detecting the unsuccessful end of a database transaction may be advantageous because it may be performed quickly and thus may save processing resources because it may prevent the following issues. An application developer may need to determine which SQL errors imply a transaction rollback and which do not. Since there are 1000s of SQL errors, it may be impossible to check all of them. Additionally, relying on the documentation of those errors may not be that reliable since the documentation could be incomplete or wrong. Another dimension of this problem may be the future development of the database system emitting the SQL errors e.g. new errors may be added. That could require adjustments in the application code responsible for the error handling.

### BRIEF DESCRIPTION OF THE DRAWINGS

In the following embodiments of the invention are explained in greater detail, by way of example only, making reference to the drawings in which:

FIG. 1 is a diagram of a computer system in accordance with an example of the present subject matter.

FIG. 2 is a flowchart of a method for executing a database transaction in accordance with an example of the present subject matter.

FIG. 3 is a flowchart of a method for executing a database transaction in accordance with an example of the present subject matter.

FIG. 4 is a flowchart of a method for executing a set of database transactions in accordance with an example of the present subject matter.

FIG. 5 is a flowchart of a method for executing a set of database transactions in accordance with an example of the present subject matter.

FIG. 6 is a flowchart of a method for executing a set of database transactions in accordance with an example of the present subject matter.

FIG. 7 is a flowchart of a method for executing a set of database transactions in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The set of database transactions may be processed following a predefined order. The entry of the first database transaction may be added in the detection storage at the beginning of the first database transaction. And the entry of each subsequent database transaction may be added in the detection storage immediately after determining that the database transaction has ended or at the beginning of the subsequent transaction. The entry may, for example, be a row. If it is determined that the database transaction has ended, the method may end for this database transaction; the method may, for example, be repeated for a next database transaction. That is, the step of executing the operation, the step of determining whether the detection storage is empty and the step of determining the database transaction has ended based on the detection storage may be repeated for a current operation in case its preceding operation did no induce the end of the database transaction.

According to one embodiment, the method further comprises determining whether an execution error has occurred for the operation and in response to determining that the error occurred, performing the determining whether the detection storage is empty. This embodiment may enable to detect the end of unsuccessful database transactions only. This may particularly be advantageous during a debugging process or development process of the database system. The present subject matter may speed up these processes and may thus increase the availability of transaction systems such as automated teller machines (ATMs).

According to one embodiment, the detection storage is a temporary table, wherein the temporary table is automatically emptied if the database transaction ends, wherein the determining that the detection storage is empty comprises determining that the table does not comprise any entry, wherein the end of the transaction is a successful or unsuccessful end. The set of database transactions may be received from a same application at the database system.

The database system may support different types of tables, each of which may have its own purpose and characteristics. The database system may support, for example, temporary tables and base tables (also referred to as regular base tables). Each of the temporary table and the base table may be referred to by multiple applications. However, each individual application process that refers to a created temporary table has its own distinct instance of the table. That is, if application process A and application process B both use a created temporary table, neither application process has access to or knowledge of the rows in the other's instance of the temporary table; applications A and B may use a table with the same name. By contrast to this, all programs and users that refer to a base table refer to the same instance of the base table. Therefore, emptying the temporary table regardless of how the transaction ends may be advantageous because it is associated or assigned to a single application. However, emptying the base table may be limited to unsuccessful ends of the transactions. For example, if two applications have access to a same base table, that base table may not be emptied by one application A if the transaction is successfully ended for A because the other application B may need the content of the table.

According to one embodiment, the set of database transactions are received at the database system from an application via a same established connection between the application and the database system, wherein the detection storage is provided upon the connection is established.

According to one embodiment, the detection storage is a regular base table. The method further comprises modifying the database transaction by adding an operation to the database transaction. The added operation is the adding of the entry. Thus, a rollback of the database transaction enables the automatic deletion of the entry, wherein the end of the transaction is an unsuccessful end. By contrast to a temporary table, the base table may be referenced (or referred to) by multiple applications. Therefore, the cleaning or the emptying of the base table may be controlled such that it does not affect the applications. This embodiment may delete the entries associated with unsuccessfully ended transactions. Thus, the present subject matter may advantageously be used with different applications. According to one embodiment, the set of database transactions are received from multiple applications. According to one embodiment, the set of database transactions are received via different connections between one or more applications and the database system.

The entries of successfully ended transactions may be maintained in the detection storage. In particular, if the detection storage is shared across multiple connections or transactions, more and more values may accumulate over time. Thus, the detection storage's size would grow and that makes the lookup for the values in the detection storage slower. The present subject matter may solve this issue by pruning the detection storage in order to reduce its size and/or reuse at least part of that entries for next transactions. According to one embodiment, the method further comprises removing one or more entries of the detection storage based at least one of: the one or more entries are associated with no-longer running transactions, the one or more entries are associated with database transactions of a connection that is to be closed, the age of the one or more entries is older than a threshold, an application associated with the one or more entries being restarted. In other words, all values of the detection storage of the current connection may be deleted right before the disconnect. A backup mechanism may be used if there is a gap in case the connection is broken prematurely. In addition, a transaction ID may be stored explicitly with each row, which enables a cross-check with the IDs of the currently running transactions. If the cross-check detects a row for a no longer running transaction, that row may be deleted. There may be no race condition if this deletion happens concurrently to the end-of-transaction detection—the transaction is finished anyway. Other pruning mechanisms could use a time-based approach, i.e. if the maximum transaction age cannot exceed a certain time interval, all rows older than that time interval may be deleted. And, if the application itself restarts, it can prune the table because all its connections and transactions are terminated anyway and will have to be restarted.

According to one embodiment, the detection storage is at least one of: an SQL session variable, a special register, a table, a temporary table and a regular base table. All those implementation options have in common that the application code may merely have to query the transaction status, and may not be concerned with maintaining this information by any means. The database engine or the Open Database Connectivity (ODBC)/ Java Database Connectivity (JDBC) driver may be configured to perform that maintaining.

The variable/special register may be set by the database engine to “0” or “false” (or similar) if a database transaction is committed or rolled back (explicitly or implicitly due to some other failure), and at the beginning of a new transaction the variable/special register is set to “1” or “true” (or similar). Determining whether the detection storage is empty may be performed by checking the value of the register. An application can query the variable/special register to detect whether a previously running transaction is still active or was finished: VALUES<global-variable-name> or SELECT<global-variable-name>.

According to one embodiment, the method further comprises providing an application comprising instructions that when executed causes the database system to perform the method. This may enable to implement the present subject matter in an application that uses a database system. This may particularly be advantageous for debugging and development applications as they may need to control all steps of the execution of the transactions by the database system.

According to one embodiment, the application is remotely connected to the database system.

According to one embodiment, the method is automatically performed by the database system. The method may automatically be performed upon receiving at the database system a first database transaction of the set of database transactions. This may enable to implement the method as a feature of the database system itself. That may reduce the complexity of the application itself. For example, the database system may create and populate the detection storage (e.g. a temporary table) itself whenever a new SQL transaction (with data modifications) is started. The application may merely have to run one of the SQL statements to query that table, e.g. SELECT COUNT(*) FROM “end_of_transaction_detection”. The result of that query gives the indication whether a transaction is currently active. This can be implemented in the database engine itself. An alternative is to implement the handling of the temporary table in the ODBC/JDBC driver code.

In one example, if the application handles all the steps of the method, the application may have to: create the detection storage, populate the detection storage at begin of the transaction, and check the detection storage after each SQL statement execution. In another example, if the DBMS implements the steps, the application may only have to handle the step of checking the detection storage after each SQL statement execution. The latter may be much simpler. The application may have to query the detection storage because that is the component who may be interested in knowing whether the transaction has finished.

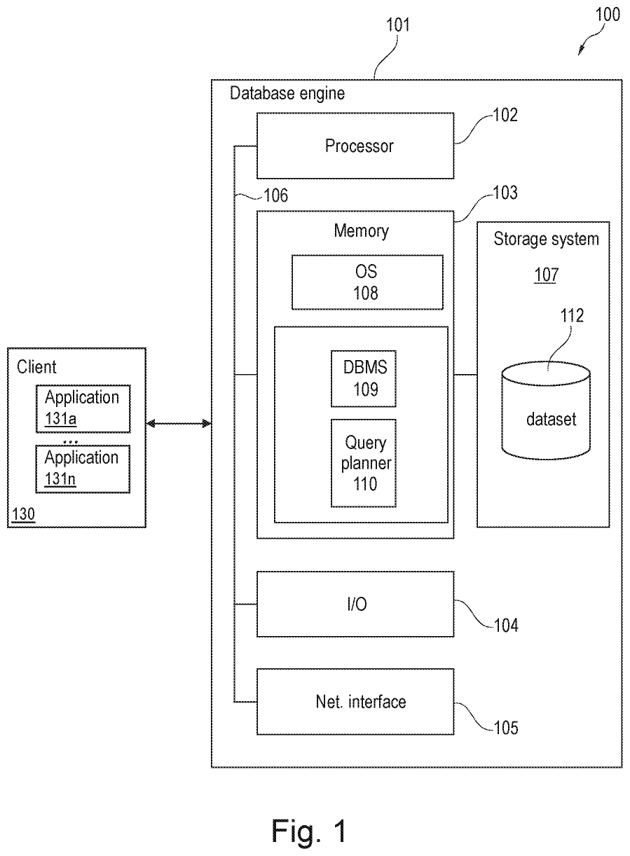

FIG. 1 is a block diagram for a data processing system 100 suited for implementing steps involved in the disclosure. The data processing system 100 comprises a computer system 101 (also referred to as database engine or database system). The computer system 101 may be responsible for lookup in transactional workloads (OLTP) or be responsible for data scans in the scope of analytical applications (OLAP), which may require to read large amounts of data in a single query.

The computer system 101 includes processor 102, memory 103, I/O circuitry 104 and network interface 105 coupled together by bus 106.

Processor 102 may represent one or more processors (e.g. microprocessors). The memory 103 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM)). Note that the memory 103 can have a distributed architecture, where various components are situated remote from one another, but can be accessed by the processor 102.

Memory 103 in combination with storage system 107 may be used for local data and instruction storage. Storage system 107 includes one or more persistent storage devices and media controlled by I/O circuitry 104. Storage system 107 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like. Storage system 107 may further include a cache 114.

Memory 103 may include one or more separate programs e.g. database management system DBMS 109 and query planner 110, each of which comprises an ordered listing of executable instructions for implementing logical functions, notably functions involved in embodiments of this invention. The software in memory 103 shall also typically include a suitable operating system (OS) 108. The OS 108 essentially controls the execution of other computer programs for implementing at least part of methods as described herein.

DBMS 109 may have access to and/or control of a dataset 112 stored in storage system 107. The DBMS 109 may use the SQL language for defining and manipulating the dataset 112. The dataset 112 may comprise a relational database. The dataset 112 may, for example, comprise transaction data that provides real time or near real time transaction data for OLTP analysis such as postings from a manufacturing control system. The dataset 112 may be stored in different format. The formats may differ in encryption, compression, row-oriented vs. column-oriented storage, etc.

The computer system 101 may be configured to connect to at least one client system 130. The client system 130 and the computer system 101 may operate in accordance with client-server configuration. The client system 130 comprises applications 131a through 131n. Each of the applications 131a through 131n may be configured to process or execute database transactions using the computer system 101. Each of the applications 131a through 131n may be configured to connect to the computer system 101 through one or more connections. A connection may be physical communication channel. Moreover, a communication session may be established at a certain point in time during the connection, and may end at some later point during the connection. The established session may involve more than one message in each direction between the application 131a -131n and the database engine 101. The session may, for example, be SQL session.

The computer system 101 may support different types of tables, each of which may have its own purpose and characteristics. The computer system may support, for example, temporary tables and base tables. The temporary table and the base table may be DB2 temporary table and DB2 base table respectively. The temporary table may be defined by the SQL statement CREATE GLOBAL TEMPORARY TABLE or DECLARE GLOBAL TEMPORARY TABLE to hold data temporarily.

A created global temporary table may be defined with the SQL CREATE GLOBAL TEMPORARY TABLE statement. The DB2 catalog table, SYSIBM.SYSTABLES, stores the description of the created temporary table. The description of the table is persistent and sharable. However, each individual application process (e.g. 131a) that refers to a created temporary table has its own distinct instance of the table. That is, if application process 131a and application process 131b both use a created temporary table named TEMPTAB: each application process uses the same table description and neither application process has access to or knowledge of the rows in the other's instance of TEMPTAB.

A declared global temporary table may be defined with the SQL DECLARE GLOBAL TEMPORARY TABLE statement. The DB2 catalog table does not store a description of the declared temporary table. Therefore, neither the description nor the instance of the table is persistent. Multiple application processes can refer to the same declared temporary table by name, but they do not actually share the same description or instance of the table. For example, assume that application process 131a defines a declared temporary table named TEMP1 with 15 columns. Application process 131b defines a declared temporary table named TEMP1 with 5 columns. Each application process uses its own description of TEMP1; neither application process has access to or knowledge of rows in the other application's instance of TEMP1.

Typically, a rollback operation may be initiated from the application 131a-n using one of the available programming languages e.g. that support commitment control. These types of rollback operations are known as explicit rollback requests. In some instances, a rollback operation is initiated by the database system e.g. for a commitment definition. These types of rollback operations are known as implicit rollback requests.

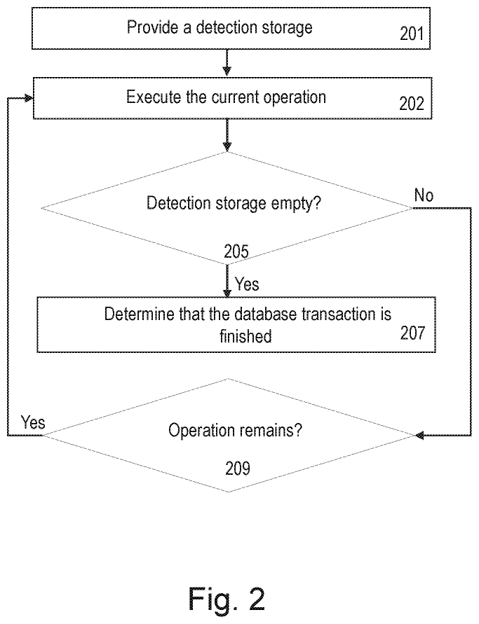

FIG. 2 is a flowchart of an approach for executing a database transaction TR1 in a database engine 101 in accordance with an example of the present subject matter. For the purpose of explanation, the method described in FIG. 2 may be implemented in the system illustrated in FIG. 1, but is not limited to this implementation.

The database transaction TR1 comprises a set of operations. The set of operations may, for example, be a sequence of data operations that may be executed in accordance with a given order. The database engine 101 may receive the database transaction from the application 131a. The database transaction TR1 may be received via a connection that is established between the application 131a and the database engine 101. The database transaction TR1 may, for example, comprise the following sequence of SQL statements.

CREATE VIEW v1 AS SELECT * FROM table1

CREATE VIEW v2 AS SELECT * FROM table2

CREATE VIEW v3 AS SELECT * FROM table3

COMMIT

Each of the SQL statements represents a respective operation of the set of operations. All those SQL statements are grouped into the database transaction TR1 because the application semantics may require atomicity, that means all the SQL statements have to be executed together. That is, an individual commit of each individual “CREATE VIEW” statement may not be performed.

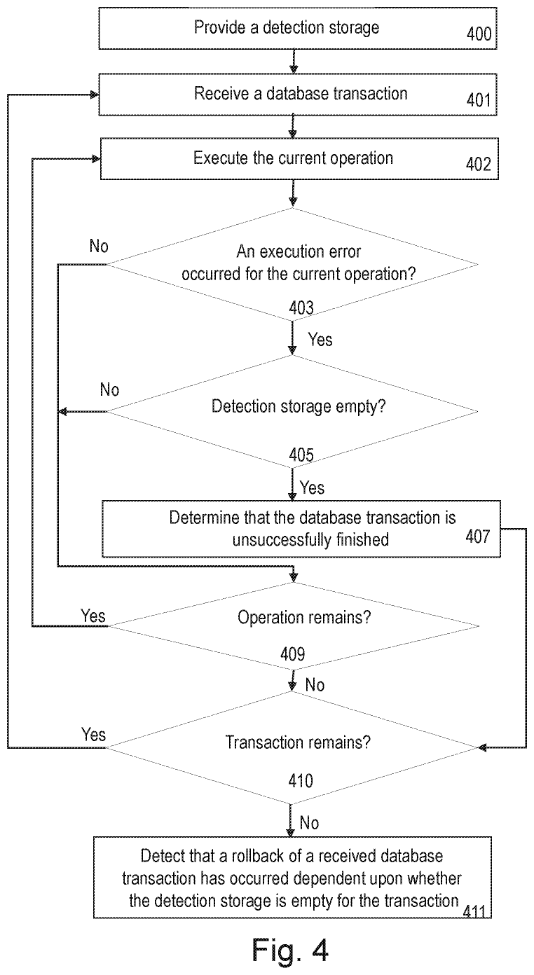

The database transaction TR1 may, for example, be a single database transaction received from the application 131a. FIG. 4 provides an example involving multiple database transactions.

Before the set of operations of the database transaction TR1 are executed, a detection storage may be provided in step 201. An entry of the database transaction TR1 may be added (e.g. in step 201) to the detection storage. The detection storage may be provided after the connection has been established between the application 131a and the database engine 101 or at the beginning of the database transaction TR1. The database engine 101 may, for example, receive through the connection from the application 131a an instruction that when executed by the database engine 101 provides the detection storage. In another example, the database engine 101 may automatically provide the detection storage. The database engine 101 is configured to automatically delete the entry of a database transaction e.g. TR1, if the database transaction ends.

The providing of the detection storage may, for example, comprise creating a table in the database engine 101. The created table may, for example, be a regular base table or a temporary table. The temporary table may be advantageous as the database engine 101 may be configured to process the temporary tables per established connection. For example, the database engine 101 may automatically empty the temporary table if the transaction associated with the temporary table has ended, wherein the transaction may end successfully or unsuccessfully. If the transaction has been rolled back it ends unsuccessfully. If a commit operation is performed, this indicates that the transaction ended successfully. Using a temporary table (whether created global temporary table or declared global temporary table) may have another advantage that the table's content may always be specific for the current connection/SQL session. Thus, the content for connection A may be completely independent of the content for connection B. Each of the connections may be associated with a respective application 131a-n. This implies that both connections may use the same name for the temporary table without conflict. But connection-specific table names may be used as well. The temporary table may, for example, be defined as follows:

DECLARE GLOBAL TEMPORARY TABLE “end_of_transaction_detection”
(“indicator” INT NOT NULL)
ON COMMIT DELETE ROWS
NOT LOGGED
ON ROLLBACK DELETE ROWS;

INSERT INTO “end_of_transaction_detection” VALUES 1).

The detection storage may be used to execute the database transaction TR1. For example, the set of operations may be executed following their order as follows. The current operation may be executed in step 202. Moreover, it may be determined (step 205) whether the entry of the database transaction TR1 is not present in the detection storage. This step may enable to determine whether the detection storage still comprises the entry of the database transaction TR1. For example, in case of processing a single transaction e.g. TR1, it may be sufficient to check in step 205 that the whole detection storage is empty.

Following the above example of the temporary table, step 205 may be performed using one of the following SELECT statements.

SELECT COUNT(*) FROM “end_of_transaction_detection”,

SELECT 1 FROM “end_of_transaction_detection”, and

SELECT “indicator” FROM “end_of_transaction_detection”.

Each of the SLECT statements enables to detect whether the table is empty or not. The first statement will return a count of 0 while the other two statements return an empty result set.

In case the detection storage is determined to be empty, it may be determined in step 207 that the database transaction TR1 has ended either successfully or unsuccessfully and the method may end for the transaction TR1 e.g. and perform the method for a next transaction. For example, an information may be saved in step 207 in the database engine 101 indicating that the database transaction TR1 has ended. As indicated with inquiry step 209, steps 202 to 207 may be repeated for each operation of the set of operations e.g. following their order. As indicated in FIG. 2, steps 202 to 207 may be repeated for a current operation in case its preceding operation of the transaction TR1 did no induce the end of the transaction TR1.

This approach may provide a simplified and automatic way to detect transactions which are finished. The present approach may not only work for implicit rollbacks, but it may also be used by the application 131a to react on regular COMMIT or ROLLBACK statements. That means, the application code may not have to implement such reactions for ODBC calls like SQLEndTran( ) and for again for the implicit transaction detection; it may be sufficient to implement the reaction in step 207. The present approach may cover all transactions ending cases and, thus, may reduce complexity in the application code. The check for an empty detection table may be performed unconditionally and not dependent on the occurrence of SQL errors.

The approach of FIG. 2 may automatically be performed by the database engine 101. For example, a set of instructions may be received by the database engine 101 from the application 131a. Upon receiving the set of instructions, the database engine 101a may automatically execute the set of instructions, wherein the execution of the set of instruction comprises the execution of the steps of the method of FIG. 2. In other words, the application 131a uses the database engine 101 to implement the approach of FIG. 2.

In another example, the approach may be implemented as a feature of the database engine 101 itself. That may reduce the complexity of the application itself. The application may merely have to run a SQL statement to query the detection storage to determine whether the detection storage is empty after each operation execution in order to determine whether the transaction has finished.

In another example, the database transaction TR1 may be part of a sequence of transactions of the application 131a. The steps 201 to 209 (or steps 202 to 209) of FIG. 2 may, for example, be repeated for each database transaction of the sequence following their order.

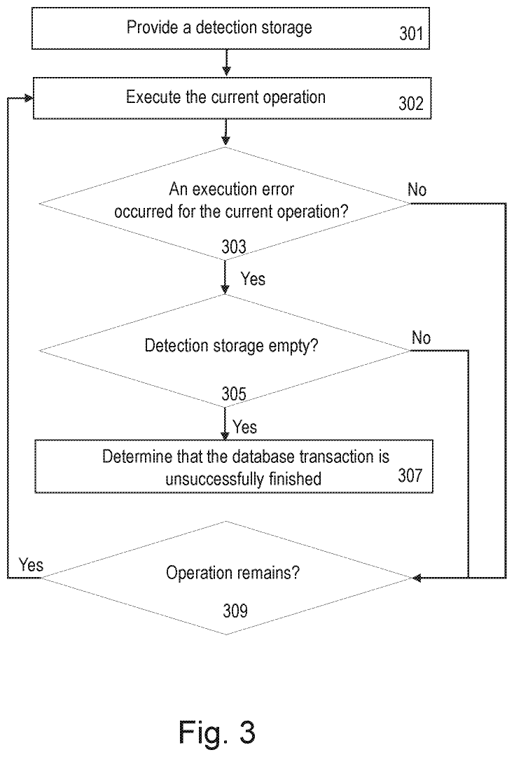

FIG. 3 is a flowchart of an approach for executing a database transaction TR1 in a database engine 101 in accordance with an example of the present subject matter. For the purpose of explanation, the approach described in FIG. 3 may be implemented in the system illustrated in FIG. 1, but is not limited to this implementation.

The database transaction TR1 comprises a set of operations. The set of operations may, for example, be a sequence of data operations that may be executed in accordance with a given order. The database engine 101 may receive the database transaction from the application 131a. The database transaction TR1 may be received via a connection that is established between the application 131 and the database engine 101.

The database transaction TR1 may, for example, be a single database transaction received from the application 131a. FIG. 4 provides an example involving multiple database transactions.

Before the set of operations of the database transaction TR1 are executed, a detection storage may be provided in step 301. An entry of the database transaction TR1 may be added (e.g. in step 301) to the detection storage. The detection storage may be provided after the connection has been established or at the beginning of the database transaction TR1. The database engine 101 may, for example, receive through the connection from the application 131a an instruction that when executed by the database engine 101 provides the detection storage. In another example, the database engine 101 may automatically provide the detection storage. The database engine 101 is configured to automatically delete the entry of a database transaction e.g. TR1, if the database transaction ends.

The providing of the detection storage may, for example, comprise creating a table in the database engine 101. The created table may, for example, be a regular base table or a temporary table. The temporary table may be advantageous as the database engine 101 may be configured to process the temporary tables per established connection. For example, the database engine 101 may automatically empty the temporary table if the transaction associated with the temporary table has ended, wherein the transaction may end successfully or unsuccessfully. If the transaction has been rolled back it ends unsuccessfully. If a commit operation is performed, this indicates that the transaction ended successfully. Using a temporary table (whether created global temporary table or declared global temporary table) may have another advantage that the table's content may always be specific for the current connection/SQL session. Thus, the content for connection A may be completely independent of the content for connection B. each of the connections may be associated with a respective application 131a-n. This implies that both connections may use the same name for the temporary table without conflict.

The detection storage may be used to execute the database transaction TR1. For example, the set of operations may be executed following their order as follows. The current operation may be executed in step 302. Moreover, it may be determined in step 303 if an execution error is occurred for the current data operation of the database transaction TR1. For example, while the current data operation being executed, a monitoring may be performed in order to detect any error that is caused by the execution of the current data operation. However, an error may or may not induce transaction rollback. For example, there are several SQL errors that indicate an error has occurred which required a rollback of the transaction, for instance if a deadlock has occurred or a severe system error was encountered. It may, thus, further be determined whether the detected error indicates that a transaction rollback of the database transaction TR1 has been performed. In particular, it may be determined (step 305) whether the entry of the database transaction TR1 is not present in the detection storage. This step may enable to determine whether the detection storage still comprises the entry of the database transaction TR1. For example, in case of processing a single transaction e.g. TR1, it may be sufficient to check in step 305 that the whole detection storage is empty.

In case the detection storage is determined to be empty, it may be determined that the database transaction TR1 has ended unsuccessfully in step 307 and the method may end for the transaction TR1. For example, an information may be saved in step 307 in the database engine 101 indicating that the database transaction TR1 has unsuccessfully ended by a rollback.

As indicated with inquiry step 309, steps 302 to 307 may be repeated for each operation of the set of operations e.g. following their order. As indicated in FIG. 3, steps 302 to 307 may be repeated for a current operation in case its preceding operation did no induce the end of the transaction.

This may provide a simplified and automatic way to detect transactions which are rolled back without having to analyze every error that has been induced during execution of the database transactions.

The approach of FIG. 3 may automatically be performed by the database engine 101. For example, a set of instructions may be received by the database engine 101 from the application 131a. Upon receiving the set of instructions, the database engine 101 may automatically execute the set of instructions, wherein the execution of the set of instructions comprise the execution of the steps of the approach of FIG. 3. In other words, the application 131a uses the database engine 101 to implement the approach of FIG. 3. In another example, the approach may be implemented as a feature of the database engine 101 itself. That may reduce the complexity of the application 131a itself. The application may merely have to run a SQL statement to query the detection storage to determine whether the detection storage is empty after each operation execution in order to determine whether the transaction has finished.

In another example, the database transaction TR1 may be part of a sequence of transactions of the application 131a. The steps 301 to 309 (or steps 302 to 309) of FIG. 2 may, for example, be repeated for each database transaction of the sequence following their order.

FIG. 4 is a flowchart of an approach for executing a set of database transactions TR1, TR2 . . . TRN in a database engine 101. For the purpose of explanation, the approach described in FIG. 4 may be implemented in the system illustrated in FIG. 1, but is not limited to this implementation. The set of database transactions TR1, TR2 . . . TRN may be received from one or more of the applications 131a-n at the database engine 101. For example, the set of database transactions may be received from multiple applications 131a-n at the database engine via different connections. Assuming for simplification of the description that the database transactions may be processed following ascending order of their indices 1 to N.

A detection storage may be provided in step 400. The detection storage may be provided at the beginning of a first established communication session between the applications 131a-n and the database engine 101. The communication sessions may be established between the applications 131a-n and the database engine 101 in order to perform the method (on database transactions of the application 131a-n) during the communication sessions. The detection storage may, for example, be a regular base table or a temporary table. This approach may enable to use one detection table across all concurrent connections. In that case, each connection (or even each transaction) may have to use a specific, unique value that can be added to entries of database transactions of the connection.

The database transaction TR1 may be received in step 401. At the beginning of the current database transaction TR1, an entry ENTRY1 (e.g. a table row) may be inserted in the provided detection storage. The entry ENTRY1 is associated with the current database transaction TR1. For example, a transaction ID may be included in the entry ENTRY1 in order to uniquely identify the current database transaction TR1. The operation of adding the entry ENTRY1 may be included in step 401 as part of the current database transaction TR1. This may enable to rollback said operation in case the current database transaction TR1 is rolled back. This may particularly be advantageous in case of regular base tables.

The detection storage may be used to execute the current database transaction TR1. For example, the set of operations of the current database transaction TR1 may be executed following their order as follows. The current operation may be executed in step 402. Moreover, it may be determined in step 403 if an execution error is occurred for the current data operation of the current database transaction TR1. For example, while the current data operation being executed, a monitoring may be performed in order to detect any error that is caused by the execution of the current data operation. However, an error may or may not induce transaction rollback. The database engine 101 is configured to delete the entry ENTRY1 of the database transaction TR1 if an error of an operation occurred and that error requires a rollback of the transaction. This may be enabled for a base table because the insertion of the entry ENTRY1 in the table is part of the current database transaction TR1. It may, thus, further be determined whether the detected error indicates that a transaction rollback of the database transaction TR1 has been performed. In particular, it may be determined (step 405) whether the entry ENTRY1 of the database transaction TR1 is not present in the detection storage. This step may enable to determine whether the detection storage still comprises the entry ENTRY1 of the database transaction TR1. The following select statement may be used in step 405:

SELECT 1

FROM “end_of_transaction_detection_for_transaction_<xid>”

WHERE value=<unique_value>”.

In case the entry ENTRY1 associated with the current database transaction TR1 is not present in the detection storage, it may be determined that the current database transaction TR1 has ended unsuccessfully in step 407. For example, an information may be saved in step 407 in the database engine 101 indicating that the current database transaction TR1 has unsuccessfully ended by a rollback. In addition, a new entry ENTRY2 associated with the next database transaction TR2 may be created in the detection storage. The insertion of the entry ENTRY2 may be performed as part of step 407 or as part of step 401.

As indicated with inquiry step 409, steps 402 to 407 may be repeated for each operation of the set of operations of the current database transaction TR1. As indicated in FIG. 4, steps 402 to 407 may be repeated for a current operation in case its preceding operation did no induce the end of the transaction. And as indicated with inquiry step 410, steps 401 to 409 may be repeated for each database transaction of the set of database transactions TR1, TR2 . . . TRN. For example, steps 401 to 409 may be repeated for database transaction TR2 using TR2 as the current database transaction instead of TR1 and so on. This may, for example, result in N entries in the detection storage (e.g. being a base table) in case none of the transactions ended unsuccessfully, wherein each entry is associated with a respective database transaction of the set of database transactions TR1, TR2 . . . TRN.

The resulting detection storage may advantageously be used by the present subject matter. For each database transaction of the set of database transactions TR1, TR2.. TRN, it may be determined (step 411) whether a database transaction of the set of database transactions TR1, TR2 . . . TRN was rolled back by just checking whether the entry associated with the database transaction exists in the detection storage. This may provide a simplified and automatic way to detect transactions which are rolled back without having to analyze every error that has been induced during execution of the database transactions.

In one example, step 411 may be performed after each iteration of the steps 401 to 410. That is, step 411 may be executed for checking the end of the database transactions TR1, then be executed after the first iteration to check the end of database transactions TR2 and so on. In another example, step 411 may be performed each time a predefined minimum number of iterations of the steps 401 to 410 is performed. For example, step 411 may be performed after the first ten database transactions have been processed to check their end, then step 411 may be performed again after the second ten database transactions have been processed to check their end and so on. In another example, step 411 may be performed after processing all transactions of the set of database transactions.

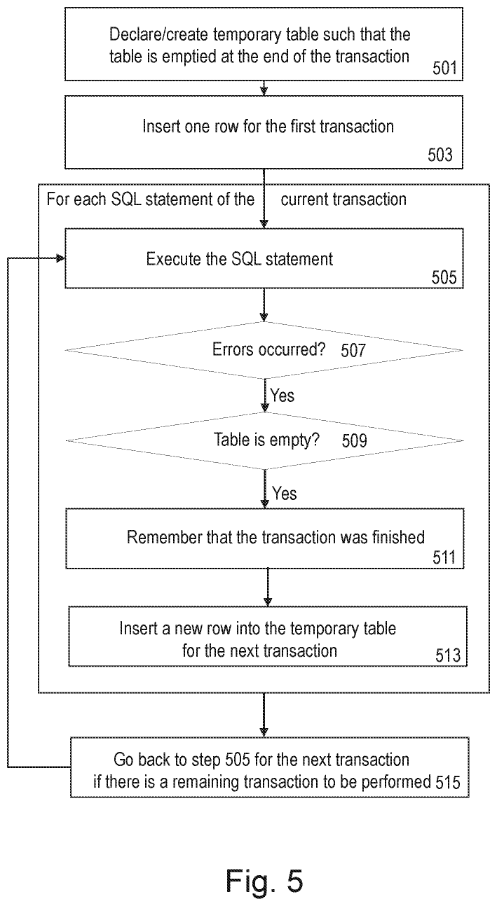

FIG. 5 is a flowchart of an approach for executing a set of database transactions in a database engine 101. For the purpose of explanation, the approach described in FIG. 5 may be implemented in the system illustrated in FIG. 1, but is not limited to this implementation. In step 501, a temporary table may be created such that the table is emptied at the end of the transaction. The temporary table may be created using, for example, the SQL command CREATE or DECLARE. The temporary table is defined in such a way to be emptied at the end of the transaction, i.e. upon COMMIT or ROLLBACK statements and also upon implicit rollbacks. In step 503, a row may be inserted in the table for the first transaction of the set of database transactions. For each SQL statement of a transaction, steps 505 to 513 may be performed. In step 505, the SQL statement may be executed. A check for errors of the execution may be performed in step 507. In case an error is occurred, it may be determined (step 509) if the table is empty. In case the table is empty, it may be remembered in step 511 that the transaction was finished and a new row may be inserted into the temporary table for the next transaction in step 513. If the temporary table is not empty, the transaction was not finished. In step 515, it may be decided to go back to step 505 in order to repeat steps 505 to 515 for the next transaction of the set of database transactions. The next transaction is a transaction that is not yet processed by the method.

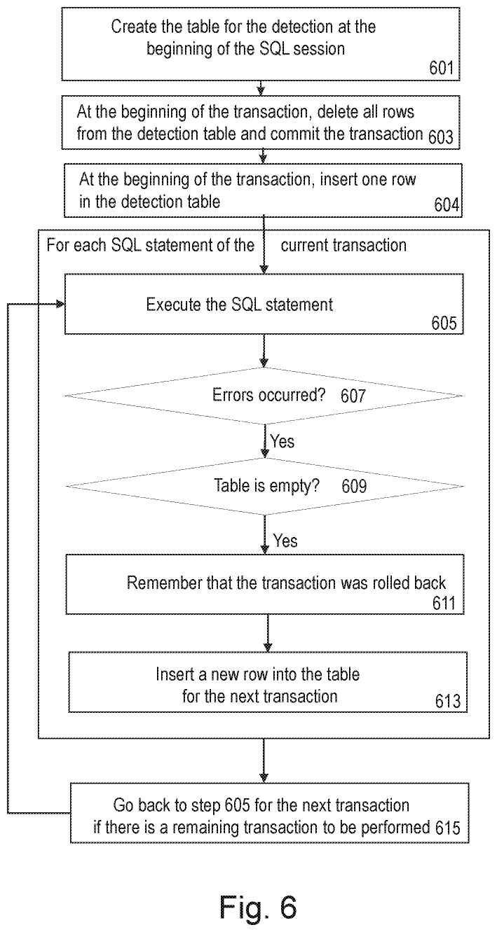

FIG. 6 is a flowchart of a method for executing a set of database transactions in a database engine 101. For the purpose of explanation, the method described in FIG. 6 may be implemented in the system illustrated in FIG. 1, but is not limited to this implementation. In step 601, a detection table may be created at the beginning of a SQL session between the application 131a and the database engine 101. At the beginning of a transaction, all rows may be deleted in step 603 from the detection table, and one row may be inserted in step 604 in the detection table. Step 603 may be performed using SQL commands as follows:

DELETE FROM “end_of_transaction_detection_for_transaction_<xid>”;

COMMIT.

For each SQL statement of a transaction, steps 605 to 613 may be performed. In step 605, the SQL statement may be executed. A check for errors of the execution may be performed in step 607. In case an error is occurred, it may be determined (step 609) if the table is empty. In case the table is empty, it may be remembered in step 611 that the transaction was rolled back and a new row may be inserted into the table for the next transaction in step 613. In step 615, it may be decided to go back to step 605 in order to repeat steps 605 to 615 for the next transaction of the set of database transactions. The next transaction is a transaction that is not yet processed by the method.

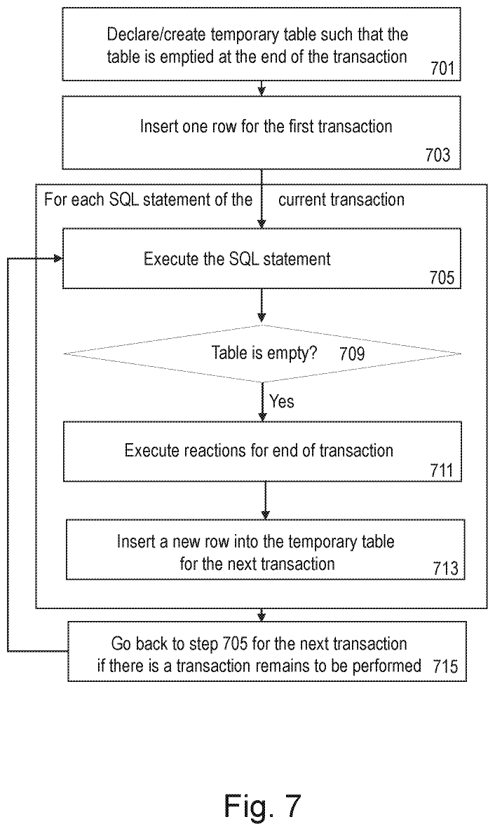

FIG. 7 is a flowchart of an approach for executing a set of database transactions in a database engine 101. For the purpose of explanation, the method described in FIG. 7 may be implemented in the system illustrated in FIG. 1, but is not limited to this implementation. In step 701, a temporary table may be created such that the table is emptied at the end of the transaction. The temporary table may be created using, for example, the SQL command CREATE or DECLARE. In step 703, a row may be inserted in the table for the first transaction of the set of database transactions. For each SQL statement of a transaction, steps 705 to 713 may be performed. In step 705, the SQL statement may be executed. It may be determined (step 709) if the table is empty. In case the table is empty, reactions may be executed for end of transaction in step 711 and a new row may be inserted into the temporary table for the next transaction in step 713. If the temporary table is not empty, the transaction was not finished. In step 715, it may be decided to go back to step 705 to 715 for the next transaction of the set of database transactions. The next transaction is a transaction that is not yet processed by the method. The present approach may not only work for implicit rollbacks, but it may also be used by the application to react on regular COMMIT or ROLLBACK statements. That means, the application code may not have to implement such reactions for ODBC calls like SQLEndTran( ) and for again for the implicit transaction detection; it is sufficient to implement the reaction in step 711. That may cover all cases and, thus, may reduce complexity in the application code. The only required change (compared to the method of FIG. 5) may be to perform the check for an empty detection table unconditionally and not dependent on the occurrence of SQL errors.

The present subject matter may comprise the following clauses.

1. A computer implemented method for executing a set of one or more database transactions in a database system, the database transaction comprising a set of operations, the method comprising providing a detection storage configured such that an entry of a database transaction that is stored in the detection storage is automatically deleted in case the database transaction ends, the method comprising for each database transaction of the set of database transactions: adding an entry in the detection storage; executing the database transaction, the execution comprising for each operation of the set of operations: executing the operation; determining whether the detection storage is empty, the determining that the detection storage is empty comprising determining whether the detection storage does not comprise at least the entry of the database transaction; determining that the database transaction has ended if the detection storage is determined to be empty.

2. The method of clause 1, further comprising determining whether an execution error occurred for the operation; in response to determining that the error occurred, performing the determining whether the detection storage is empty.

3. The method of clause 1 or 2, the detection storage being a temporary table, wherein the table is automatically emptied if the transaction ends, wherein the determining that the detection storage is empty comprises determining whether the table does not comprise any entry, wherein the end of the transaction is a successful end or unsuccessful end.

4. The method of any of the preceding clauses, the set of database transactions being received from an application via an established connection between the application and the database system, wherein the detection storage is provided upon the connection being established.

5. The method of clause 1, 2 or 4, the detection storage being a regular base table, the method further comprising modifying the database transaction by adding an operation to the database transaction, the operation being the adding of the entry, thereby a rollback of the database transaction enabling the automatic deletion of the entry, wherein the end of the transaction is an unsuccessful end.

6. The method of clause 1 or 5, the set of database transactions being received via different connections between one or more applications and the database system.

7. The method of clause 1 or 5 or 6, further comprising removing one or more entries of the detection storage based at least one of: the one or more entries being associated with no-longer running transactions; the one or more entries being associated with database transactions of a connection that is to be closed; the age of the one or more entries being older than a threshold; an application associated with the one or more entries being restarted.

8. The method of any of the preceding clauses, further comprising providing an application comprising instructions that upon execution cause the database system to perform the method.

9. The method of clause 8, the application being remotely connected to the database system.

10. The method of any of the preceding clauses, being automatically performed.

11. The method of clause 1, 2, 8, 9 or 10, wherein the detection storage is at least one of: an SQL session variable, a special register, a table, a temporary table and a regular base table.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for executing a set of one or more database transactions in a database system, the computer implemented method comprising:
providing a detection storage configured such that an entry of a database transaction that is stored in the detection storage is automatically deleted in case the database transaction ends, wherein the database transaction comprises a set of operations; and
for each database transaction of a set of database transactions:
adding, by one or more processors, an entry in the detection storage; and
executing, by one or more processors, the database transaction, the execution comprising, for at least one operation of the set of operations:
executing, by one or more processors, the at least one operation;
determining, by one or more processors, that the detection storage is empty based on the detection storage not comprising at least the entry of the database transaction; and
responsive to determining that the detection storage is empty, determining, by one or more processors, that the database transaction has ended.

2. The computer implemented method of claim 1, further comprising:
determining, by one or more processors, that an execution error occurred for the at least one operation; and
wherein determining that the detection storage is empty is responsive to determining that the error occurred.

3. The method of claim 1, wherein:
the detection storage is a temporary table;
the temporary table is automatically emptied if the transaction ends; and
determining that the detection storage is empty comprises determining, by one or more processors, that the table does not comprise any entry.

4. The method of claim 1, wherein:
the set of database transactions are received from an application via an established connection between the application and the database system; and
the detection storage is provided upon the connection being established.

5. The method of claim 1, wherein the detection storage is a regular base table, further comprising:
modifying, by one or more processors, the database transaction by adding an operation to the database transaction, the operation being the adding of the entry.

6. The method of claim 1, wherein the set of database transactions are received via different connections between one or more applications and a database system.

7. The method of claim 1, further comprising:
removing, by one or more processors, one or more entries of the detection storage based on a selection from the group consisting of: the one or more entries being associated with no-longer running transactions; the one or more entries being associated with database transactions of a connection that is to be closed; an age of the one or more entries being older than a threshold; and an application associated with the one or more entries being restarted.

8. The method of claim 1, wherein the detection storage is selected from the group consisting of: an SQL session variable, a special register, a table, a temporary table, and a regular base table.

9. A computer program product for executing a set of one or more database transactions in a database system, the computer program product comprising:
one or more computer readable storage media, and program instructions collectively stored on the one or more computer readable storage media, the program instructions comprising:
program instructions to provide a detection storage configured such that an entry of a database transaction that is stored in the detection storage is automatically deleted in case the database transaction ends, wherein the database transaction comprises a set of operations; and
for each database transaction of a set of database transactions:
program instructions to add an entry in the detection storage; and
program instructions to execute the database transaction, the program instructions to execute comprising, for at least one operation of the set of operations:
program instructions to execute the at least one operation;
program instructions to determine that the detection storage is empty based on the detection storage not comprising at least the entry of the database transaction; and
program instructions to, responsive to determining that the detection storage is empty, determine that the database transaction has ended.

10. The computer program product of claim 9, further comprising:
program instructions, collectively stored on the one or more computer readable storage media, to determine that an execution error occurred for the at least one operation; and
wherein program instructions to determine that the detection storage is empty is responsive to determining that the error occurred.

11. The computer program product of claim 9, wherein:
the detection storage is a temporary table;
the temporary table is automatically emptied if the transaction ends; and
program instructions to determine that the detection storage is empty comprise program instructions to determine that the table does not comprise any entry.

12. The computer program product of claim 9, wherein:
the set of database transactions are received from an application via an established connection between the application and the database system; and
the detection storage is provided upon the connection being established.

13. The computer program product of claim 9, wherein the detection storage is a regular base table, further comprising:
program instructions, collectively stored on the one or more computer readable storage media, to modify the database transaction by adding an operation to the database transaction, the operation being the adding of the entry.

14. The computer program product of claim 9, wherein the set of database transactions are received via different connections between one or more applications and a database system.

15. The computer program product of claim 9, further comprising:
program instructions, collectively stored on the one or more computer readable storage media, to remove one or more entries of the detection storage based on a selection from the group consisting of: the one or more entries being associated with no-longer running transactions; the one or more entries being associated with database transactions of a connection that is to be closed; an age of the one or more entries being older than a threshold;
and an application associated with the one or more entries being restarted.

16. The computer program product of claim 9, wherein the detection storage is selected from the group consisting of: an SQL session variable, a special register, a table, a temporary table, and a regular base table.

17. A computer system for executing a set of one or more database transactions in a database system, the computer system comprising:
one or more computer processors, one or more computer readable storage media, and program instructions collectively stored on the one or more computer readable storage media for execution by at least one of the one or more computer processors, the program instructions comprising:
program instructions to provide a detection storage configured such that an entry of a database transaction that is stored in the detection storage is automatically deleted in case the database transaction ends, wherein the database transaction comprises a set of operations; and
for each database transaction of a set of database transactions:
program instructions to add an entry in the detection storage; and
program instructions to execute the database transaction, the program instructions to execute comprising, for at least one operation of the set of operations:
program instructions to execute the at least one operation;
program instructions to determine that the detection storage is empty based on the detection storage not comprising at least the entry of the database transaction; and
program instructions to, responsive to determining that the detection storage is empty, determine that the database transaction has ended.

18. The computer system of claim 17, further comprising:
program instructions, collectively stored on the one or more computer readable storage media for execution by at least one of the one or more computer processors, to determine that an execution error occurred for the at least one operation; and
wherein program instructions to determine that the detection storage is empty is responsive to determining that the error occurred.

19. The computer system of claim 17, wherein:
the detection storage is a temporary table;
the temporary table is automatically emptied if the transaction ends; and
program instructions to determine that the detection storage is empty comprise program instructions to determine that the table does not comprise any entry.

20. The computer system of claim 17, wherein:
the set of database transactions are received from an application via an established connection between the application and the database system; and
the detection storage is provided upon the connection being established.
